(19) United States
(12) Patent Application Publication
(10) Pub. No.: US 2003/0152158 A1
(43) Pub. Date: Aug. 14, 2003

(54) Method of asymmetrical forward error correction in a communication system. application to wireless local area networks (WLAN) using turbo codes and low density parity check codes

(75) Inventors: Juan Alberto Torres, Orchard Park, NY (US); Victor Demjanenko, Lockport, NY (US)

Correspondence Address: Robert P. Simpson, Esq., Simpson & Simpson, PLLC, 5555 Main Street, Williamsville, NY, 14221-5406, US

(73) Assignee: VoCAL Technologies, Ltd., Buffalo, NY

(21) Appl. No.: 10/361,465

(22) Filed: Feb. 10, 2003

Related U.S. Application Data
(60) Provisional application No. 60/356,039, filed on Feb. 11, 2002.

(51) Int. Cl. H04L 5/12

(52) U.S. Cl. 375/265

(57) ABSTRACT

A method of asymmetrical forward error correction for a communication link having two communication directions, comprising a first type of forward error correction method in a first direction of the communication link and a second type of forward error correction method in a second direction of the communication link, where the first and second types of forward error correction methods are different.

### RELATED APPLICATION

This patent application claims the benefit under 35 USC §119(e) of U.S. Provisional Application Serial No. 60/356,039, filed Feb. 11, 2002, incorporated by reference herein. U.S. patent application Ser. No. 10/079,202 filed on Feb. 19, 2002 entitled, “Method and Apparatus for Configurable or Asymmetric Forward Error Correction” is also incorporated herein by reference.

### FIELD OF THE INVENTION

The present invention relates to a new coding technique that uses a different Forward Error Correction (FEC) technique in each direction of the communication link, so implementing an asymmetrical Forward Error Correction in a communication system. In this patent application this technique is applied to Wireless Local Area Network (WLAN) using Turbo Code (TC) and Low Density Parity Check codes (LDPC) as the two different FEC techniques. An example of wireless LAN could be the one specified on the IEEE 802 group (standards IEEE802.11, IEEE802.11a, IEEE802.11b and IEEE802.11g) or the ETSI group (HIPERLAN type 1 and 2 standards) all hereby referenced as 802.11a/b/g.

### BACKGROUND OF THE INVENTION

In the case of the IEEE 802.11a/b/g WLAN standard, the modulation used in the transmitter is QAM modulation, from a BPSK to 64 QAM. This means that the highest modulation uses 3 bits in each dimension I and Q. For this type of QAM modulation, all the bits shall be encoded. The transmitter is an OFDM-like system. This includes all the systems that use an IFFT-type encoding, sending the information in parallel subcarriers. These coding techniques use puncturing tables to reduce the coding rate. In this patent the punctured tables are presented. Similar punctured tables can be created with similar performance.

This patent covers different symmetrical and asymmetrical application cases:

a) The case when TC is used in both directions (to transmit and to receive data).

b) The case when TC is used in one direction (to send or to receive data).

c) The case when LDPC code is used in both directions (to transmit and to receive data)

d) The case when LDPC code is used in one direction (to transmit or to receive data)

e) The case when Turbo codes are used in one direction (to transmit or to receive data) and LDPC code is used in the other direction (to receive or to transmit data).

TC and LDPC codes presented in this patent also cover the cases of full coding (where all the information bits are coded), called Full Turbo Code (FTC) and full Low Density Parity Check codes (FLDPC) and Multi-level coding (where only some bits with the lower weight are coded) call Multi-Level Turbo Code (MLTC) and Multi-Level Low Density Parity Check Code (MLDPC).

Because of the puncturing process, more protection shall be given to the parity bits in the case of Turbo Codes and Low Density Parity Check codes. This means that the parity bits are assigned to most significant constellation bits. This patent also includes, the case in which the parity bits are not the more protected bits.

Non-squared constellations are also considered in this patent. How to use them is described in U.S. patent application Ser. No. 09/991,372, filed Nov. 13, 2001, and entitled, “System and Method Using Multi-Dimensional Constellations with Low Receiver Soft-Decision Extraction Requirements”, incorporated herein by reference (hereinafter referred to as the ′372 application). On their own, the use of non-square constellations (without the advance coding presented in this patent) will provide mode/speed/selection coverage. Wireless standards now use 16 QAM and 64 QAM constellations using independent I and Q decoding. With the non-square constellation disclosed in the ′372 application, one can use 8 QAM and 32 QAM constellations with independent I and Q decoding. Previously, non-square constellations were not considered in the standard because the lack of methods for efficient decoding of non-square constellations with independent I and Q decoding. The method presented in the ′372 application permits the decoding of non-square constellations with a computational burden of the same order of magnitude of the square constellations.

The TC and LDPC code techniques presented in this application can be applied to systematic (where information bits are sent to the channel) and to non-systematic (where only coded information bits are sent to the channel) encoders. In both cases TC and LDPC codes produce performances of more than 6 dB with respect to the Convolutional Codes that are used currently. This results in a greater throughput, increase in the operating range of the system and/or reduce the power consumption of the system.

### SUMMARY OF THE INVENTION

The present invention broadly comprises a method of asymmetrical forward error correction for a communication link having two communication directions, comprising a first type of forward error correction method in a first direction of the communication link, and, a second type of forward error correction method in a second direction of the communication link, where the first and second types of forward error correction methods are different.

A general object of the invention is to provide an improved method of asymmetrical forward correction for a communication link.

A secondary object of the invention is to provide a more efficient method of asymmetrical forward correction for a communication link that optimizes available overhead in each direction of communication in the link.

These and other objects, features, and advantages of the invention will become readily apparent to those having ordinary skill in the art in view of the following detailed description, when read in conjunction with the several drawings and claims.

### BRIEF DESCRIPTION OF THE DRAWINGS

FIG. 1 illustrates a communication system that uses this technique;

FIG. 2a illustrates multi-level gray mapping for 4-ASK;

FIG. 2b illustrates multi-level gray mapping for 8-ASK,

FIG. 2c illustrates multi-level gray mapping for 16-ASK;

FIG. 3 illustrates convolution coding of IEEE802.11a,

FIG. 4 illustrates puncturing case A;

FIG. 5 illustrates puncturing case B;

FIG. 6 illustrates application of TC to IEEE802.11a,

FIG. 7 illustrates IEEE802.11a with TC and a code rate of ¾ mode I;

FIG. 8 illustrates IEEE802.11a with TC and a code rate of ¾ mode II;

FIG. 9 illustrates IEEE802.11a with TC and a code rate of ⅔;

FIG. 10 illustrates IEEE802.11a with TC and a code rate of ⅚,

FIG. 11 illustrates IEEE802.11b with TC;

FIG. 12 illustrates data rates of IEEE802.11a, IEEE802,11a with TC/LDPC, IEEE802.11b, and IEEE802.11b with TC/LDPC;

### DETAILED DESCRIPTION OF THE PREFERRED EMBODIMENT

In the description that follows, the following acronyms are used:

| | |
|---|---|
| CC: | Convolutional Codes. |
| DBPSK: | Differential Binary Phase Shit Key |
| DQPSK: | Differential Quadrature Phase Shift Key |
| ETSI: | European Telecommunication Standard Institute |
| FEC: | Forward Error Correction. |
| FLDPC: | Full Low Density Parity Check codes (all information bits |
| | are encoded) |
| FTC: | Full Turbo Code (all information bits are encoded) |
| IEEE: | Institute of Electrical and Electronic Engineers |
| LAN: | Local Area Networks |
| LDPC: | Low Density Parity Check codes |
| MLDPC: | Multi-Level Low Density Parity Check Codes (no all |
| | information bits are encoded) |
| MLTC: | Multi-Level Turbo Codes (no all information bits are encoded) |
| QAM: | Quadratic Amplitude Modulation in I and Q dimensions. |
| QoS: | Quality of Service. |
| TC: | Turbo Codes |
| WLAN: | Wireless Local Area Networks. |

In this application, the term “no coding” is used in the sense that all the bit are sent uncoded to the channel, the term “Convolutional Codes” (CC) is used in the sense that the bits are coded with convolutional encoders (see G. D. Forney, Jr., “Concatenated Codes”, MIT press 1966). The well known Trellis Coding is an example of ordinary Convolutional Coding. The term “Turbo Codes” is used in the sense that the bits are coded with two encoders using an interleaver between them (see Benedetto, Divsalar, Montorsi and F. Pollara, “A Soft-Output Maximum A Posteriori (MAP) Module to Decode Parallel and Serial Concatenated Codes”, The Telecommunications and Data Acquisition Progress Report 42-127, Jet Propulsion Laboratory, Pasadena, Calif., pp. 1-20, Nov. 15, 1996). The term, “Low Density Parity Check” codes is used in the sense that the bits are coded in the transmitter using a Low Density Parity Check matrix (see R. G. Gallager, “Low Density Parity Check Codes”, MIT Press 1963).

TC and LDCP codes are coding techniques that allow communications close to the capacity of the channel or theoretical limit (Shannon limit). Each has its advantages and disadvantages.

TC is simple on the transmitter side; the only “extra” device used with respect to Convolutional Codes is an interleaver. On the receiver side, TC is more complex, requiring two receivers working in parallel interchanging information between them, performing a number of iterations. These iterations need processing time and memory. In some cases, TC can have an “error floor” that reduces the effectiveness of the codes. The “error floor” can be avoided using a good design for the interleaver, such as ones described in U.S. patent application, Ser. No. 09/846,061, filed Apr. 30, 2001, and entitled, “Use of Turbo-like Codes for QAM Modulation Using Independent I and Q Decoding Techniques and Applications to xDSL Systems”, incorporated herein by reference (hereinafter referred to as the ′061 application).

LDPC codes are complex in the transmitter, where they need to determine a good LDPC matrix. It has been proven that with big matrices (in the order of 1 million bits), it is possible to be as close as 0.0045 dB from the Shannon limit. In the receiver side, LDPC codes are easy to decode, similar to decoding a linear code.

It is clear that these two techniques are complementary to each other. TC fits well in devices where the encoding must be simple to save power. LDPC code fits in devices where the decoding must be simple to save power. Taking this into account, for handset or mobile devices, where power consumption is important, one could use TC in the uplink (sending data) and LDPC codes in the downlink (receiving data) to optimize the power consumption. The access point or. base station equipment is usually powered from a standard AC source.

The present invention broadly comprises a method of asymmetrical forward error correction for a communication link having two communication directions, comprising: a first type of forward error correction method in a first direction of the communication link, and, a second type of forward error correction method in a second direction of the communication link, where the first and second types of forward error correction methods are different.

The method of the previous paragraph is implemented wherein the first type of forward error correction method is selected from the group consisting of Turbo Coding, Full Turbo Codes, Multi-Level Turbo Codes, Low Density Parity Check Codes, Full Low Density Parity Check Codes, Multi-Level Parity Check Codes, Trellis Coding, and Reed Solomon Coding; and, wherein the second type of forward error correction method is selected from the group consisting of Turbo Coding, Full Turbo Codes, Multi-Level Turbo Codes, Low Density Parity Check Codes, Full Low Density Parity Check Codes, Multi-Level Parity Check Codes, Trellis Coding, and Reed Solomon Coding.

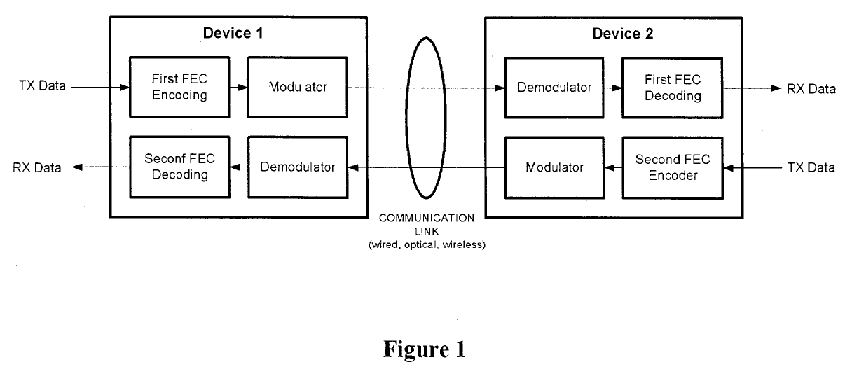

The invention also comprises a method of asymmetrical forward error correction for a communication link having two communication directions, where a first type of forward error correction method is used in a first direction of the communication link, and, a second type of forward error correction method is used in a second direction of the communication link, the method comprising the following steps: producing in a first device a first encoded stream by applying a first forward error coding encoding method to a first data stream, transmitting the first encoded stream over the communication link to a second device; receiving the first encoded stream in the second device, decoding the first encoded stream by applying a first forward error coding decoding method to produce a first reconstructed data stream, producing in the second device a second encoded stream by applying a second forward error coding encoding method to a second data stream, wherein the second forward error coding encoding method is different than the first forward error coding encoding method; transmitting the second encoded stream over a communication link to the first device; receiving the second encoded stream in the first device; and, decoding the second encoded stream by applying a second forward error coding decoding method to produce a second reconstructed data stream. This process can be seen in FIG. 1.

In one embodiment of the method, the communication link is a component of a wired communications system: In another embodiment, the communication link is a component of a wireless communications system. In one embodiment, the communication link is a component of a wireless Local Area Network. In another embodiment, the communication link is a component of an Optical System.

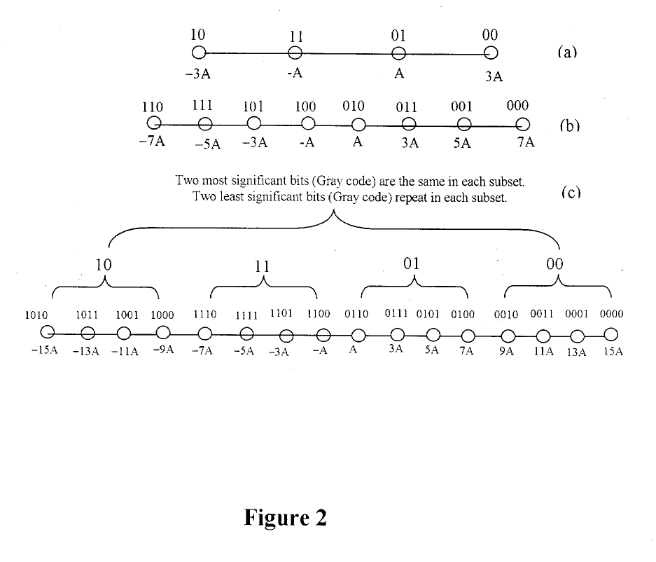

This patent also includes the case where not all the information bits are encoded. For low order constellations (less or equal to 16 QAM), all the bits shall be encoded to obtain a good performance. For high order constellations (more than 16 QAM), only the first 2 bits can be encoded and other bits are sent uncoded using a multilevel Gray mapping as defined in FIG. 2 for a 16 QAM, 64 QAM and 256 QAM. This technique was also considered in the ′372 and ′061 application cited previously.

Application of TC to the IEEE802.11a/g and HIPERLAN 2 Standards for Wireless LAN

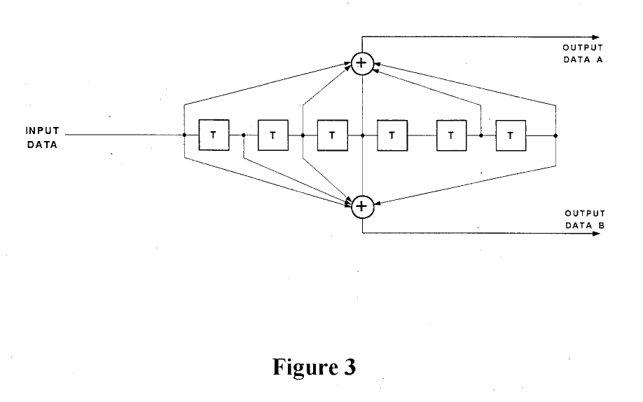

The technique described herein can be applied to the IEEE802.11a/g standard wireless LAN and the European standard HIPERLAN 2. These standards use ordinary CC encoding (Trellis) to encode the signal. The CC encoder is a non-systematic convolutional encoder, as shown in FIG. 3. The convolutional encoder uses the standard generator polynomials, g₀=133₈ and g₁=171₈, of rate R=½.

The wireless LAN standards currently recommend puncturing as of the following:

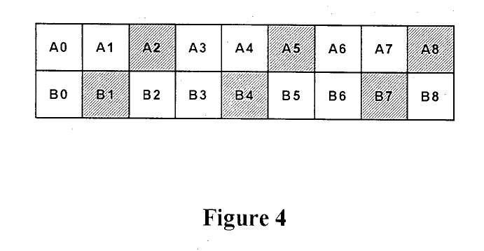

A) No puncturing at time t, puncturing output B at t+1, puncturing output A at t+2, and repeating with a period of 3. In this case the coding rate is ¾. This case is shown in FIG. 4.

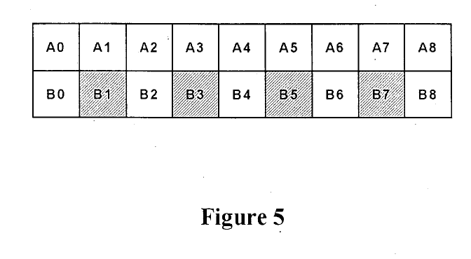

B) Puncturing only one output. In this case, output data A is never punctured and output data B is punctured one every other time. In this case the coding rate is ⅔. This case is shown in FIG. 5.

A box in grey represents an output that is completed but not sent to the channel because of the puncturing.

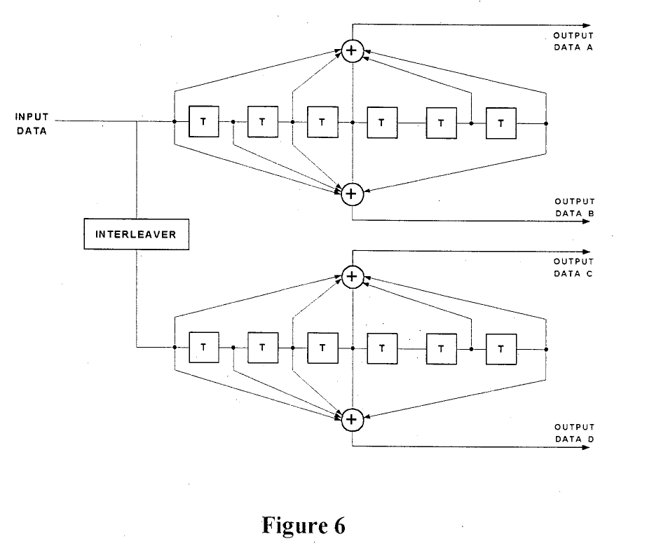

To incorporate TC in this structure, two convolutional encoders (using the standard generator polynomials, g₀=133₈ and g₁=171₈, of rate R=½) with an interleaver between them are used, as show in FIG. 6.

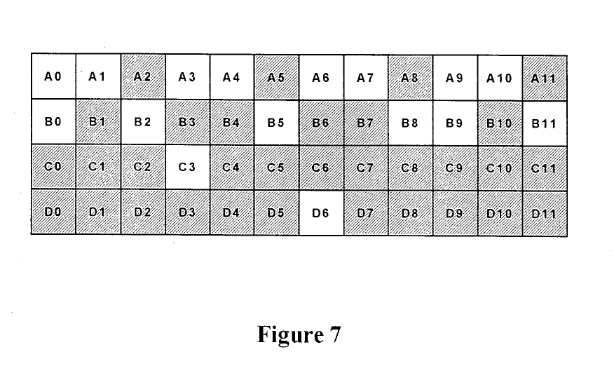

To obtain the code rate of ¾, two types of puncturing may be used. Puncturing mode I is shown in FIG. 7, where not all the A outputs are sent.

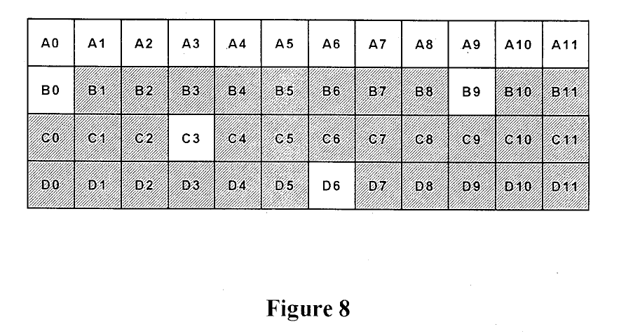

Puncturing mode II is shown in FIG. 8 where all the A outputs are sent and the puncturing is only used with outputs B, C and D.

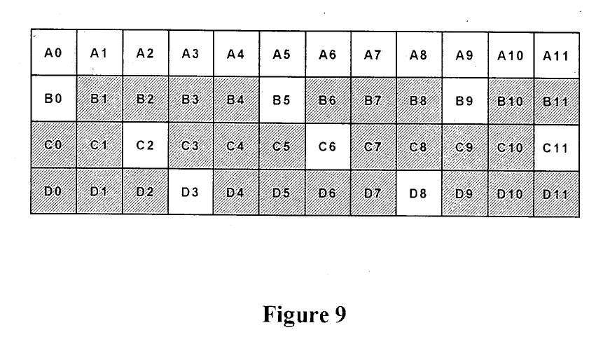

To obtain a code rate of ⅔ the puncturing to use is shown in FIG. 9.

The ′061 application described how the code gain of these code with respect to the IEEE802.11a/g standard is greater than 6 dB.

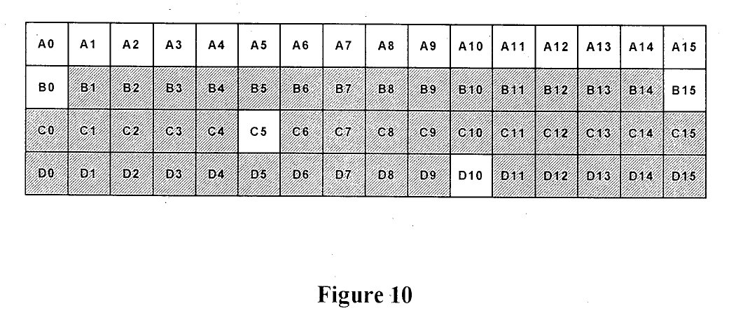

It is also possible to increase the data rate of the ′802.11a/g standard by increasing the code rate using high puncturing. FIG. 10 shows a code rate of ⅚, increases the data rate up to 60 Mbps. We can keep increasing the coding rate with a maximum limit of 72 Mbps of data rate for the ¾ code rate.

In a similar way for the ⅔ code rate, by increasing the puncturing, i.e., using fewer parity bits, the maximum data rate will be 81 Mbps.

Application of TC to the IEEE802.11b Standard and HIPERLAN 1 Standard

In the case of IEEE802.11b, the codification used is BPSK for 1 and 5.5 Mbps and QPSK for 2 and 11 Mbps. In this case, TC codes maybe used to increase the reach and coverage area reducing the data rate.

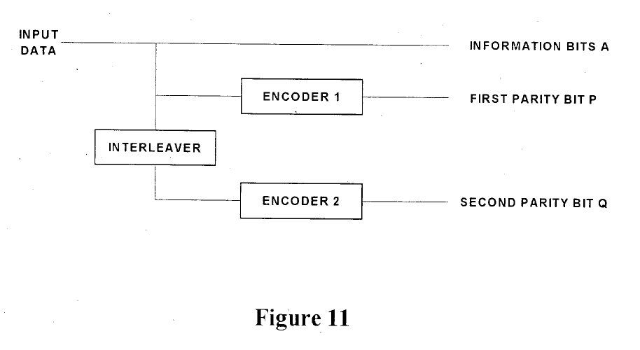

The information bits are encoded with a simple encoder and interleaver, as shown in FIG. 11.

This codification will reduce the data rate in proportion to the code rate used, e.g., if the code rate is ½ (r=½), this means that the parity bits are puncturing one every other bit, so the information bits will be:

A0, A1, A2, A3, A4, A5, . . . the first encoder will sent to the channel:

P0, P2, P4, . . . and the second encoder will sent to the channel:

Q1, Q3, Q5, . . .

In this implementation half of the bits sent to the channel are information bits and half are parity bits. The order bits sent to the channel for DBPSK or DQPSK encoding will be:

A0, P0, A1, Q1, A2, P2, A3, Q3, A4, P4, A5, Q5, . . .

Higher puncturing can be used with a very good performance, e.g., a code rate of r=¾ will increase the data rate and will still have a very good performance. In this case only one parity bit is sent to the channel every 3 information bits, so the data rate will be ¾ of the data rate without Forward Error Correction (FEC). The information bits sent to the channel will be:

A0, A1, A2, A3, A4, A5, A6, A7, A8, A9, A10, A11, . . . the first encoder will sent to the channel:

P0, P6, P12, . . . and the second encoder will sent to the channel:

Q3, Q9, Q15, . . .

The order bits sent to the channel for DBPSK orDQPSK encoding will be:

A0, P0, A1, A2, A3, Q3, A4, A5, A6, P6, A7, A8, A9, Q9, A10, A11, A12, P12, A13, . . .

The closer the coder rate is to 1, the closer the data rate is to the 802.11b standard. For the DBPSK encoder, the basic access rate is specified in Table 1.

TABLE 1
1 Mbps DBPSK Encoding Table

| Bit input | Phase change (+jw) |
|---|---|
| 0 | 0 |
| 1 | π |

The DQPSK encoder is specified in Table 2.

TABLE 2
2 Mbps DQPSK Encoding Table

| | d0 is first in time Phase |
|---|---|
| Dibit pattern (d0, d1) | change (+jw) |
| 00 | 0 |
| 01 | π/2 |
| 11 | π |
| 10 | 3π/2(−π/2) |

In the tables, +jw is defined as counterclockwise rotation. The input bit sequence is the same as what we earlier called the order of the bits sent to the channel.

Other puncturing patterns can also be used obtaining similar performance.

The coding gain of this code with respect to the IEEE802.11b is more than 6 dB.

Application of LDPC to the IEEE802.11a/b/g Standard and HIPERLAN 2 Standard

Array base LDPC codes

As seen in FIGS. 7, 8 and 9, because of the puncturing used, the TC is similar to a low-density parity check matrix. When using LDPC codes in IEEE802.11a/g and HIPERLAN 2, the parity check matrix can be chosen so that the code rate is the same as with TC.

The LDPC parity-check matrix H is defined by three parameters: a prime number p and two integers k and j such that kj>p. The matrix H has dimensions jp×kp and is given by:

$$H = [ \begin{matrix}I & I & I & ⋯ & I & I & ⋯ & I \\ 0 & I & α & ⋯ & {α}^{j - 2} & {α}^{j - 1} & ⋯ & {α}^{k - 2} \\ 0 & 0 & I & ⋯ & {α}^{2 ( j - 3 )} & {α}^{2 ( j - 2 )} & ⋯ & {α}^{2 ( k - 3 )} \\ ⋯ & ⋯ & ⋯ & ⋯ & ⋯ & ⋯ & ⋯ & ⋯ \\ 0 & 0 & ⋯ & 0 & I & {α}^{( j - 1 )} & ⋯ & {α}^{( j - 1 ) ( k - 1 )}\end{matrix} ]$$

where I is the p×p identity matrix, O is the p×p null matrix, and α is the p×p permutation matrix representing a single left shift. For example, for p=5,

$$α = [ \begin{matrix}0 & 0 & 0 & 0 & 1 \\ 1 & 0 & 0 & 0 & 0 \\ 0 & 1 & 0 & 0 & 0 \\ 0 & 0 & 1 & 0 & 0 \\ 0 & 0 & 0 & 1 & 0\end{matrix} ]$$

LDPC codes defined by H have code word length N=kp, number of parity checks M=jp, and information block length K=(k−j)p. The parity-check matrix of an LDPC with code word length N′<N or number of parity checks M′<M can be obtained by discarding the N−N′ rightmost columns and the M−M′ lowest rows of H, respectively. Thus five parameters must be specified to define the LDPC code: p, j, k, the code word length and the number of parity checks.

Efficient encoding is achieved directly from the parity-check matrix H without the need to compute the generator matrix of the code. To this end, an LDPC codeword is expressed in the form:

(x_{N-1}, x_{N-2}, . . . , x₀)=(p_{N-K-1}, p_{N-K-2}, . . . , p₀·d_{K-1}, d_{K-2}, . . . , d₀)

where (p_{N-K-1}, p_{N-K-2}, . . . , p₀) represents the parity part and (d_{K-1}, d_{K-2}, . . . , d₀) the systematic part of the code word. The parity bits (p₀,p₁, . . . , p_{N-K-1}) are recursively computed (in that order) using the constraint:

H·(x_{N-1}, x_{N-2}, . . . , x₀)^{T}=0

where T denotes vector transpose and the right-hand side of the equation represents the null vector.

In this way it is possible to build any parity check matrix of the code rate ¾ one can use 750 information bits (K=749) and 250 parity bits (N=999) with a total of 1,000 bits sent to the channel.

For a code rate of ¾ and N in the order of 4000 the coding gain with respect to the 802.11a/b/g is greater than 6 dB.

In this way it is possible to build any parity check matrix of the code rate ⅔ one can use 600 information bits (K=599) and 300 parity bits (N=899) with a total of 900 bits sent to the channel).

For a code rate of ⅔ and N in the order of 4000 the coding gain with respect to the 802.11a/b/g is also grater than 6 dB.

Diagonal base LDPC codes

In this case the LDPC parity-check matrix H with arbitrary size is defined by four parameters: code length N (number of columns), a number of parity checks M (number of rows), a number of ones in each column j, and maximum number of ones in a row (row weight limitation).

This method is a column by column distribution of ones with deterministic assignment of ones within the current column relatively to the previous one. Matrix H is initialized by two steps. The first step is the full diagonal initialization, which provides the matrix with a “1” in each column according to algorithm:

H(kk,k)=1; k=1,2, . . . , N; kk=k−M*integer[(k−1)/M)].

The second step is the first column initialization: j ones are assigned evenly according to algorithm:

H(r, 1)=1, where r=1+(i−1)*integer(M/j); i=2, . . . j.

Beginning from the second column, ones assignment is carried out as follows:

Each “1” in the previous column (an ancestor) generates “1” in the next column (a descendant).

The rule of the generation is: a descendant is placed one position below an ancestor, and generation order corresponds to decreasing ancestor positions in the column (from the bottom to the top of the matrix).

If the ancestor takes the lowest position in the descending diagonal, its descendant should take the highest free position, i.e. in the 1-st row or in the position closest to the 1-st row.

If current 1 produces any rectangle with all other ones in the current column and in previous columns, then, the position of this 1 should be changed by shifting one position down at a time up to the position, which satisfies the rectangle elimination. If there is no acceptable position, the descendant is shifted one position up at a time from the initial descendant position till it satisfies the rectangle elimination.

If a number of ones in the current column is less than j, the descendant generation for this column is repeated in opposite order, corresponding to increasing ancestor positions in the column (from the top to the bottom of the matrix). If, after that, a number of ones in the current column is still less than j, additional ones are added in the next column in the highest free positions. If number of ones in some row has reached weight limitation, the remaining part of this row is forbidden for further ones distribution and automatically filled with zeros.

From the parity-check matrix H, the generator matrix in systematic form is obtained

G_{sys}=[P|Iₖ]

where Iₖ is the Kx K identity matrix, and used for encoding the K-bit information word

d=(dₖ₋₁, dₖ₋₂, . . . , d₀) according to

x=d·G_{sys}

Hence, the code word comprises a parity part

p=(p_{N-K-1}, p_{N-K-2}, . . . , p₀)

and a systematic part equal to d:

(x_{N-1}, x_{N-2}, x₀)=(p_{N-K-1}, p_{N-K-2}, . . . , p₀, d_{K-1}, d_{K-2}, . . . , d₀)

Application of LDPC to the IEEE802.11b Standard and HIPERLAN 1 Standard

In this case, we have to introduce Forward Error Correction (FEC). This means that we will introduce redundancy in the system, so the data rate will decrease. With the LDPC codes we can control how much the data rate will decrease. In this aspect, the LDPC code will have data rate close to 0.9, so the data reduction will be low.

After encoding the signal with the LDPC process described above, the information bits and parity bits are encoded using Table 1 for DBPSK and Table 2 for DQPSK.

For a code rate of 0.85 and N in the order of 4000 the coding gain with respect to the 802.11b is greater than 6 dB.

Coverage Area Increase Using TC and/or LDPC

Because of the 6 dB of coding gain, the use of TC and/or LDPC increases the coverage area of the system.

In a wireless system dependency, the intensity of the electrical field (E) with the distance to the transmitter (r), follows the law of the inverse of the square root:

$$E = \frac{1}{{r}^{2}}$$

The attenuation of the signal in the Signal to Noise Ratio (SNR) follows the general equation of the propagation. So if a system has a 6 dB signal power increase, it is possible to compute the increase in reach due to this increase in signal power. The dependence of the SNR with the electrical field follows the following law:

$$10 {log}_{10} ( E ) = 10 {log}_{10} ( \frac{1}{{r}^{2}} , )$$

For a 6 dB of coding gain, the increase in reach is:

$$6 = 10 {log}_{10} ( E ) = 10 {log}_{10} ( \frac{1}{{r}_{2}} )$$

Then:

$$r = \sqrt{{10}^{\frac{6}{10}}} = 1.99$$

This means that the diameter of the coverage area is increased by 1.4125, because of the increase in 6 dB of SNR.

To compute the increase in the coverage area, for omni directional transmission we can use the area of a circle:

S=πr²

For r=1.99, the increase in coverage area is 4. This means that using TC and LDPC codes the increase in area is by a factor of 4, so to cover the same area, one fourth number of servers will be needed, reducing the expense of the system by a factor of 4. Of course the complexity of the system will also be reduced, because the number of units to be controlled will be reduced by 75 per cent.

For installations with only one unit the system will be able to reach more area with a higher rate than before, or reach the same area with a better Quality of Service (QoS).

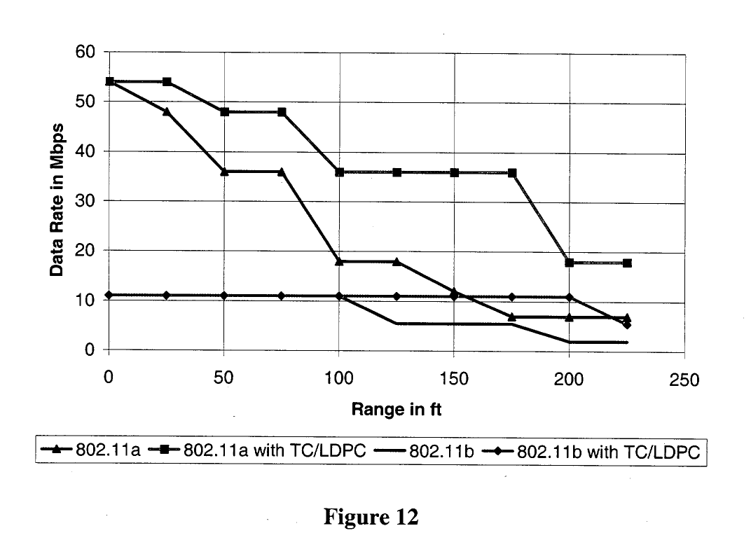

FIG. 12 shows the data rate of the standard 802.11a/b/g, standard 802.11b, 802.11a/b/g with Turbo code/LDPC and 802.11b with Turbo code/LDPC.

Thus, it is seen that the objects of the invention are efficiently obtained, although modifications and changes to the invention will be readily apparent to those having ordinary skill in the art, and these modifications are intended to be within the scope of the appended claims.

What we claim is:

1. A method of asymmetrical forward error correction for a communication link having two communication directions, comprising:
a first type of forward error correction method in a first direction of said communication link; and,
a second type of forward error correction method in a second direction of said communication link, where said first and second types of forward error correction methods are different.

2. The method recited in claim 1 wherein said first type of forward error correction method is selected from the group consisting of Turbo Coding, Full Turbo Codes, Multi-Level Turbo Codes, Low Density Parity Check Codes, Full Low Density Parity Check Codes, Multi-Level Parity Check Codes, Trellis Coding, and Reed Solomon Coding.

3. The method recited in claim 1 wherein said second type of forward error correction method is selected from the group consisting of Turbo Coding, Full Turbo Codes, Multi-Level Turbo Codes, Low Density Parity Check Codes, Full Low Density Parity Check Codes, Multi-Level Parity Check Codes, Trellis Coding, and Reed Solomon Coding.

4. A method of asymmetrical forward error correction for a communication link having two communication directions, where a first type of forward error correction method is used in a first direction of said communication link, and, a second type of forward error correction method is used in a second direction of said communication link, said method comprising the following steps:
producing in a first device a first encoded stream by applying a first forward error coding encoding method to a first data stream;
transmitting said first encoded stream over said communication link to a second device,
receiving said first encoded stream in said second device;
decoding said first encoded stream by applying a first forward error coding decoding method to produce a first reconstructed data stream,
producing in said second device a second encoded stream by applying a second forward error coding encoding method to a second data stream, wherein said second forward error coding encoding method is different than said first forward error coding encoding method;
transmitting said second encoded stream over a communication link to said first device;
receiving said second encoded stream in said first device; and,
decoding said second encoded stream by applying a second forward error coding decoding method to produce a second reconstructed data stream.

5. The method recited in claim 1 wherein said communication link is a component of a wired communications system.

6. The method recited in claim 1 wherein said communication link is a component of a wireless communications system.

7. The method recited in claim 1 wherein said communication link is a component of a wireless Local Area Network.

8. The method recited in claim 1 wherein said communication link is a component of an Optical System.

9. A method of asymmetrical forward error correction for a communication link having two communication directions, where a first type of forward error correction method is used in a first direction of said communication link, a method of forward error correction comprising:
a second type of forward error correction method in a second direction of said communication link, where said first and second types of forward error, correction methods are different.

10. A method of asymmetrical forward error correction for communication systems, comprising use of a Turbo Code encoding technique for a transmit direction and a Low Density Parity Check Code decoding technique for a receive direction

11. A method of asymmetrical forward error correction for communication systems, comprising use of a Low Density Parity Check Code encoding technique for a transmit direction and a Turbo Code decoding technique for a receive direction

12. A method of forward error correction for a wireless LAN communications system comprising the following steps:
producing in a first device a first encoded stream by applying a Turbo Code forward error coding encoding technique to a first data stream;
transmitting said first encoded stream over a communication link to a second device;
receiving said first encoded stream in said second device; and,
decoding said first encoded stream by applying a Turbo Code forward error coding decoding technique to produce a first reconstructed data stream.

13. A method of forward error correction for a wireless LAN communications system comprising the following steps:
producing in a first device a first encoded stream by applying a Low Density Parity Check Code forward error coding encoding technique to a first data stream;
transmitting said first encoded stream over a communication link to a second device;
receiving said first encoded stream in said second device; and,
decoding said first encoded stream by applying a Low Density Parity Check Code forward error coding decoding technique to produce a first reconstructed data stream.

14. A method of forward error correction for a wireless LAN communications system comprising the following steps:
producing in a first device a first encoded stream by applying a forward error coding encoding technique to a first data stream;
transmitting said first encoded stream over a communication link to a second device;
receiving said first encoded stream in said second device; and,
decoding said first encoded stream by applying a forward error coding decoding technique to produce a first reconstructed data stream.

15. The method recited in claim 14 wherein said forward error correction technique uses Turbo Coding.

16. The method recited in claim 14 wherein said forward error correction technique uses Low Density Parity Check Codes.
